(19) United States
(12) Patent Application Publication
(10) Pub. No.: US 2010/0300097 A1
(43) Pub. Date: Dec. 2, 2010

(54) HEAT ENGINE

(75) Inventors: Paul Van De Loo, Norton Summitt (AU); David Robert Barduca, Paradise (AU)

Correspondence Address: BUCHANAN, INGERSOLL & ROONEY PC, POST OFFICE BOX 1404, ALEXANDRIA, VA, 22313-1404, US

(73) Assignee: Cogen Microsystems Pty Ltd., Thebarton, South Australia (AU)

(21) Appl. No.: 12/682,735

(22) PCT Filed: Oct. 10, 2008
(86) PCT No.: PCT/AU2008/001496

§ 371 Date: Aug. 13, 2010

(30) Foreign Application Priority Data
Oct. 12, 2007 (AU) 2007905619

(51) Int. Cl. F15B 3/00; F01B 11/08; F01B 29/04; F03G 6/00

(52) U.S. Cl. 60/641.8; 417/383; 60/547.1; 60/579

(57) ABSTRACT

A heat engine includes a boiler, an injector for injecting working fluid into the boiler, a retainer for releasing the hydraulic fluid for movement away from a start position once working fluid vapour pressure in the boiler reaches a predetermined level, a returner for returning the hydraulic fluid to its start position following expansion of working fluid vapour in the boiler, resulting in reciprocating hydraulic fluid motion, and an exhaust valve to release expanded working fluid vapour from the boiler. The vapour pressure increase in the boiler causes a change of state from liquid to gas of a least a portion of the injected working fluid, followed by a substantially constant pressure heating of the working fluid, giving rise to a change of state from liquid to gas of substantially all of the remaining injected working fluid.

This international patent application claims priority from Australian provisional patent application 2007905619 filed on 12 Oct. 2007, the contents of which are to be taken as incorporated herein by this reference.

### FIELD OF THE INVENTION

The present invention relates to heat engines. In the broadest form, heat engines are simply devices that are able to convert thermal energy to mechanical work, which thus covers a broad range of engines such as steam engines, diesel engines and internal combustion engines, and other engines often referred to by the thermodynamic cycle that they utilize (such as a Rankine cycle engine or a Stirling cycle engine).

The heat engine of the present invention has been developed for use in converting solar-generated thermal energy to mechanical work for the purposes of generating electricity for use in a domestic environment. Of course, the heat engine of the present invention is not to be limited only to that use.

### BACKGROUND OF THE INVENTION

The use of Rankine cycle engines to convert heat to mechanical power is well known. Large scale Rankine cycle engines generally use a continuous flow turbine for the expansion stage, whereas small scale Rankine cycle engines generally employ a reciprocating expander (such as a piston and cylinder arrangement) as turbines are less efficient on a small scale. Indeed, steam engines, such as old railway locomotives, follow this approach.

However, such small scale Rankine cycle engines generally have efficiencies significantly less than that of typical steam turbines. In our U.S. Pat. No. 7,188,474, issues causing such low efficiencies are outlined and a more efficient heat engine is described. The main improvement described is an inlet valve that can provide short and sharp “cut-off”, although an exhaust valve mounted in the piston is also described which also has a number of advantages. In practice, such an engine works well but the complexity (and hence also cost) and durability of the inlet valve and the exhaust valve have proven to be problematic.

The aim of the present invention is to provide a heat engine from which these difficulties are eliminated or are at least significantly reduced, whilst maintaining good efficiency of operation.

### SUMMARY OF THE INVENTION

The present invention provides a heat engine that is capable of converting reciprocating motion of hydraulic fluid exiting a boiler, under the influence of working fluid vapour pressure, to useful work, the heat engine including:
the boiler;
a working fluid injecting means for injecting working fluid into the boiler;
a hydraulic fluid retaining means capable of releasing the hydraulic fluid for movement away from a start position once working fluid vapour pressure in the boiler reaches a predetermined level;
a hydraulic fluid return means to return the hydraulic fluid to its start position following expansion of working fluid vapour in the boiler, resulting in reciprocating hydraulic fluid motion;
an exhaust valve to release expanded working fluid vapour from the boiler;
   wherein the vapour pressure increase in the boiler prior to the hydraulic fluid moving away from the start position is caused by a substantially constant volume heating of working fluid causing a change of state from liquid to gas of a least a portion of the injected working fluid, followed by a substantially constant pressure heating of the working fluid giving rise to a change of state from liquid to gas of substantially all of the remaining injected working fluid.

The present invention also provides a method of operating a heat engine, the heat engine including:
a boiler;
a working fluid injecting means for injecting working fluid into the boiler;
a hydraulic fluid retaining means capable of releasing the hydraulic fluid for movement away from a start position once working fluid vapour pressure in the boiler reaches a predetermined level;
a hydraulic fluid return means to return the hydraulic fluid to its start position following expansion of working fluid vapour in the boiler;
an exhaust valve to release expanded working fluid vapour from the boiler;
   the method including the substantially constant volume heating of working fluid injected into the boiler, causing a change of state from liquid to gas of a least a portion of the injected working fluid, the resultant vapour pressure increase in the boiler causing the hydraulic fluid to move away from the start position resulting in reciprocating hydraulic fluid motion, followed by a substantially constant pressure heating of the working fluid, giving rise to a change of state from liquid to gas of substantially all of the remaining injected working fluid.

In relation to the vapour pressure increase in the boiler, in one form of the present invention the working fluid is injected as a liquid directly into hydraulic fluid (that has been heated by an external heat source) in the boiler. This results in the transfer of heat from the external heat source to the hydraulic fluid and subsequently to the working fluid, and initiates the constant volume heating and change of state of the working fluid mentioned above (in other words, the working fluid injected as a liquid starts to boil off). The heating of course continues (in the form of constant volume heating) until the working fluid vapour pressure has increased enough to cause the hydraulic fluid to start moving away from the start position, and then continues further (in the form of constant pressure heating) until substantially all of the injected working fluid has boiled off.

However, and as will be described below, in other embodiments of the present invention the liquid working fluid may be heated by more conventional heat exchange techniques, such that the transfer of heat is directly from an external heat source to the working fluid (the hydraulic fluid thus not needing to itself be heated) to provide the constant volume heating and increase in vapour pressure that causes the hydraulic fluid to move away from the start position mentioned above, followed by the constant pressure heating.

In a preferred form of the present invention, the heat engine includes, in use, hydraulic fluid above and below a separator, the hydraulic fluid above the separator being within the boiler (thus being referred to as “boiler hydraulic fluid”) and the hydraulic fluid below the separator (the “separator hydraulic fluid”) being in fluid communication with a power conversion means to convert reciprocating separator motion (and in turn the reciprocating separator hydraulic fluid motion) to useful work. The use of such a separator will often be preferred in order to benefit from the pressure multiplication and temperature differences that are achievable across a separator, and also to permit use (if desirable) of different hydraulic fluids above and below the separator.

In this form, the vapour pressure increase in the boiler prior to the separator moving away from a start position is again caused by a substantially constant volume heating of working fluid, preferably due to it being injected directly into the boiler hydraulic fluid, and a subsequent change of state from liquid to gas of a least a portion of the injected working fluid.

It will thus be appreciated that, while the broadest form of the present invention refers to the reciprocating motion (howsoever created) of hydraulic fluid exiting the boiler as being that which is ultimately converted to useful work, in at least this form of the present invention the reciprocating motion is most easily understood with regard to the reciprocating motion of a separator (or, as described below in relation to further forms of the invention, a separator in the specific form of a piston).

Before turning to a general description of various aspects of the present invention, some important points need to be made about some of the language that will be used throughout this specification.

The term “separator” has been used above to describe an element that might often be referred to as a “piston”. While a majority of the embodiments of the heat engine of the present invention are likely to involve the use of a separator in the specific form of a traditional piston, not all embodiments will do so. Thus, the general term “separator” is being used, not only in relation to the element that it represents, but also in relation to associated elements such as a “separator retaining means” and a “separator return means”.

With this in mind, the meaning thus adopted for the term “separator” where used throughout this specification is more akin to “a movable member (such as a barrier, disc or piston) fitting closely within a hollow member (such as a cylinder), and capable of being driven alternately forwards and backwards by pressure to thereby impart reciprocating motion to another member”. The separator may be in the form of a traditional piston (being a piston head with or without a piston rod on one side), or may be a simple disc-shaped member at the interface between two volumes of hydraulic fluid.

Further, some terms will be (and have been) used to define the spatial relationship of various elements of the heat engine of the present invention. In this respect, spatial references throughout this specification will generally be based upon a heat engine operating in a generally upright orientation, such that (in at least some forms of the present invention) any vapour produced in the boiler during the change of state of the working fluid generally moves upwardly away from the hydraulic fluid (and in embodiments that utilize a separator, away from the separator). With this environment as the basis, some elements may then be defined with reference to “up” or “down”, allowing further references to “above” and “below”.

Further, it will be appreciated that the boiler of the heat engine of the present invention can take many forms and can be a single integrated unit in the traditional sense, or can include a number of discrete elements that together provide the functionality required. Thus, in one form, the “boiler” of the heat engine of the present invention may include any form of heat exchanger or heat exchange system that can transfer heat to a working fluid (ideally from an external heat source) for the required heating described above. In the form of the present invention where the hydraulic fluid is heated and liquid working fluid is injected directly thereinto, the boiler, may alternatively include a heat exchanger or heat exchange system of a conventional type that can transfer heat to the hydraulic fluid (again, ideally from an external heat source).

In some forms of the present invention, the boiler may also include a volume within which at least a portion of the hydraulic fluid may be contained, the hydraulic fluid being contained in a manner such that the increase in vapour pressure of the working fluid (by any of the means described above) is able to exert a force on the hydraulic fluid to at least move the hydraulic fluid away from the start position mentioned above to commence the reciprocating motion. Of course, in an embodiment that utilises a separator of the type mentioned above, the separator is also likely to be within this boiler volume, for at least a portion of the heat engine's operating cycle.

In many forms of the invention, such heat exchangers or heat exchange systems will be conveniently located either completely or partially within the boiler volume, and the boiler volume will include a space above the hydraulic fluid (and above a separator, where used) for the working fluid vapour.

The working fluid injecting means mentioned above will normally include a pump for the controlled injection of the working fluid into the boiler (either as a liquid or substantially as a liquid, and in one form as a liquid into the hydraulic fluid directly), at a suitable location in the boiler via a working fluid injector, the working fluid pump preferably being operable via a suitable control means.

The hydraulic fluid retaining means mentioned above (being, in one form, a separator retaining means or a piston retaining means) will in one form be a retaining valve, incorporated within the line of the hydraulic fluid, located between the boiler and the power conversion means (thus, in one form, between the separator and the power conversion means). The retaining valve is preferably operable via a suitable control means, in response to working fluid pressure in the boiler. Indeed, ideally a single control means will be responsible not only for operating the retaining valve and for regulating the timing and flow of the working fluid pump (thus notionally forming a part of the working fluid injecting means), but will also be responsible for operating an exhaust valve. The preferred form and functionality of such a retaining valve will be described below in relation to an operating cycle of the heat engine.

The working fluid which changes state from liquid to gas on heating preferably circulates through the heat engine in a closed loop. In the case of a working fluid such as water (ideal for use where high temperature operation is acceptable or required), which can be replenished cheaply and easily, it is possible to operate the heat engine as an open system where the working fluid is at least partially discharged to atmosphere on exiting the exhaust valve. In this form, there would be no additional requirement for a condenser means. However, in the case of a working fluid required for use in low to medium temperature operation, the working fluid may be a conventional organic refrigerant (such as the refrigerants known by the trade marks R134a and R245fa sold by Honeywell International Inc), and the heat engine would need to be operated as a closed system with the gaseous working fluid being returned to its liquid state in a conventional manner in a condenser after exiting the exhaust valve.

The hydraulic fluid of course can be any suitable fluid that is substantially incompressible. Examples of suitable hydraulic fluids are any one or more of a large group of mineral oil, water or water-based fluids used as the medium in hydraulic systems. With this mind, the base stock for a suitable hydraulic fluid may be any one or more of castor oils, glycols, esters, ethers, mineral oils, organophosphate esters, Chutte and polyalphaolefins, propylene glycols, or silicone.

In the form of the present invention where the working fluid is injected directly into the hydraulic fluid in order for the hydraulic fluid to heat (and boil) the working fluid, the hydraulic fluid will then preferably be of a type that is substantially immiscible such that, at the interface between the hydraulic fluid and the working fluid vapour, the working fluid vapour will press on the hydraulic fluid to cause movement of the body of the hydraulic fluid without re-mixing with the hydraulic fluid.

The heat engine of the present invention preferably operates in a cycle. A convenient place in the cycle to commence a description of it is the injection of working fluid into the boiler by the working fluid injecting means, although it will be appreciated that a continuous cycle such as that operated in a heat engine of this type tends not to have an obvious start point or finish point. Also, while it is convenient to describe the general operation of the heat engine in terms of an embodiment where the liquid working fluid is injected by a pump directly into the heated hydraulic fluid, and where a separator is involved in providing the reciprocating motion of the hydraulic fluid, it will be appreciated that the present invention is not to be limited only to such an embodiment.

Turning to a general description of the operating cycle, a control means preferably operates a working fluid pump so as to inject a controlled quantity of liquid working fluid into hydraulic fluid in a boiler. The hydraulic fluid in the boiler is heated (or has been heated) by an external heat source, which in one form will be a solar heat collector. As the temperature of the liquid working fluid injected into the hydraulic fluid in the boiler increases, the change of state of the working fluid from a liquid to a gas occurs (which is effectively the boiling of the working fluid), with the amount of the working fluid changing state increasing gradually. The vapour pressure in the boiler increases (as a result of this constant volume heating) as at least a portion of the working fluid changes state to a gas. At this point, a separator is still at its notional start position and is held in place, in one form, by a separator retaining valve remaining closed.

When the vapour pressure in the boiler has increased to a predetermined threshold level, the control means causes the separator retaining valve to open, allowing the separator to move away from the notional start position under the influence of the vapour pressure of the working fluid, with the heating of the working fluid continuing under constant pressure until substantially all of the working fluid has changed state.

In one form of the invention, the control means may be integral with the separator retaining valve and may sense the force applied to the separator and then open the separator retaining valve when a threshold force is reached. In yet another form, the separator retaining means is envisaged to include mechanical stops that provide a physical retention of the separator, the stops being withdrawn in response to a signal from the control means, the signal either being boiler pressure responsive or separator force responsive.

In yet another form of the present invention, the hydraulic fluid retaining means (and thus, in one form, the separator retaining means) may be provided by the load characteristics of a power conversion means, for example by providing a load characteristic that ensures that the hydraulic fluid (or the separator) does not move substantially until substantial pressure is generated in the boiler. In this form of the present invention, there need not be a fixed boiler pressure threshold at which the hydraulic fluid (or the separator) starts to move from its start position; rather, the hydraulic fluid (or the separator) can commence its travel as the boiler pressure starts to increase, although ideally a significant proportion of this stroke will not occur until the pressure in the boiler has increased substantially, so as to produce a substantial amount of work from expanding working fluid vapour.

The motion of the hydraulic fluid under the influence of expanding working fluid vapour is of course used to do useful work, preferably by use of the power conversion means mentioned above. This can be done in a number of different ways and these are well known to persons skilled in the art. For example, the power conversion means could include the conversion of the reciprocating motion of a separator, such as a piston, into rotary motion of, for example, a crankshaft via a connecting rod. This rotary motion could then be utilised for a large number of useful purposes such as for propelling a vehicle, for driving an alternator or a generator to produce electricity, or to power a pump so as to pump water (or the like).

Returning to the description of the cycle of the heat engine of the present invention, when the separator motion is halted, either by reaching a physical stop or because the remaining pressure in the boiler is no longer sufficient to move the separator against a load, this is preferably sensed by the control means. The controller then preferably opens an exhaust valve, allowing the expanded gases of the working fluid to communicate with (in one form) a working fluid condenser. In another form of the present invention, the separator halting may cause the exhaust valve to be opened by the direct application of a mechanical linkage or other direct actuation means. In yet another form of the present invention, the exhaust valve may open automatically when the separator reaches a set position, rather than when the separator stops moving.

The operation of the exhaust valve may be direct, such as by a port in a cylinder wall becoming exposed, or may be operated by the control means monitoring a sensor that measures separator position and then actuates the exhaust valve.

In all forms of the invention, the hydraulic fluid return means then acts to move the hydraulic fluid back to its start position. In a preferred form, again one including the use of a separator, the separator return means may be a spring or other resilient means that acts on the separator. Alternatively, it may be a resilient means that acts on the hydraulic fluid which in turn acts on the separator. It may also be the hydraulic fluid being forced into the boiler, such as by a similar boiler of a second heat engine which is at a different stage of its cycle. This motion acts to expel remaining expanded working fluid vapour via the exhaust valve to the condenser, or if not a closed system using a working fluid such as a refrigerant, to atmosphere.

At this point in the description of the operating cycle, it is also convenient to explain the possible use of normal reciprocating engine terms such as “top dead centre (TDC)” and “bottom dead centre (BDC)”. The above description has referred to a notional start position for a separator and also to a position where the motion of a separator halts. In relation to conventional heat engines (with traditional piston and cylinder arrangements) these two positions might be referred to as TDC and BDC respectively. While these two references will sometimes be used below when describing at least some of the preferred embodiments of the present invention, they are being used for convenience and ease of understanding and are not to be regarded as being limiting. Indeed, in some forms of the invention that do not require a generally upright configuration, TDC may occur at a location that is lower than (or below) BDC.

### BRIEF DESCRIPTION OF THE DRAWINGS

Having briefly described the general concepts involved with the present invention, several preferred embodiments of a heat engine in accordance with the present invention will now be described. However, it is to be understood that the following description is not to limit the generality of the above description.

In the drawings:

FIG. 1 is a flow diagram of a heat engine in accordance with a first preferred embodiment of the present invention;

FIG. 2 is a flow diagram of a heat engine in accordance with a second preferred embodiment of the present invention;

FIG. 3 is a flow diagram of a heat engine in accordance with a third preferred embodiment of the present invention;

FIG. 4a is a flow diagram of a heat engine in accordance with a fourth preferred embodiment of the present invention;

FIG. 4b is a flow diagram showing an alternate boiler arrangement for use with the embodiment shown in FIG. 4a;

FIG. 5 is a flow diagram of a heat engine in accordance with a fifth preferred embodiment of the present invention;

FIG. 6 is a timing diagram showing the key elements of the operating cycle for the fifth embodiment of FIG. 5; and

FIG. 7 is a temperature-entropy (TS) thermodynamic cycle diagram illustrating the operating cycle for the four embodiments of FIGS. 1 to 5.

### DETAILED DESCRIPTION OF THE DRAWINGS

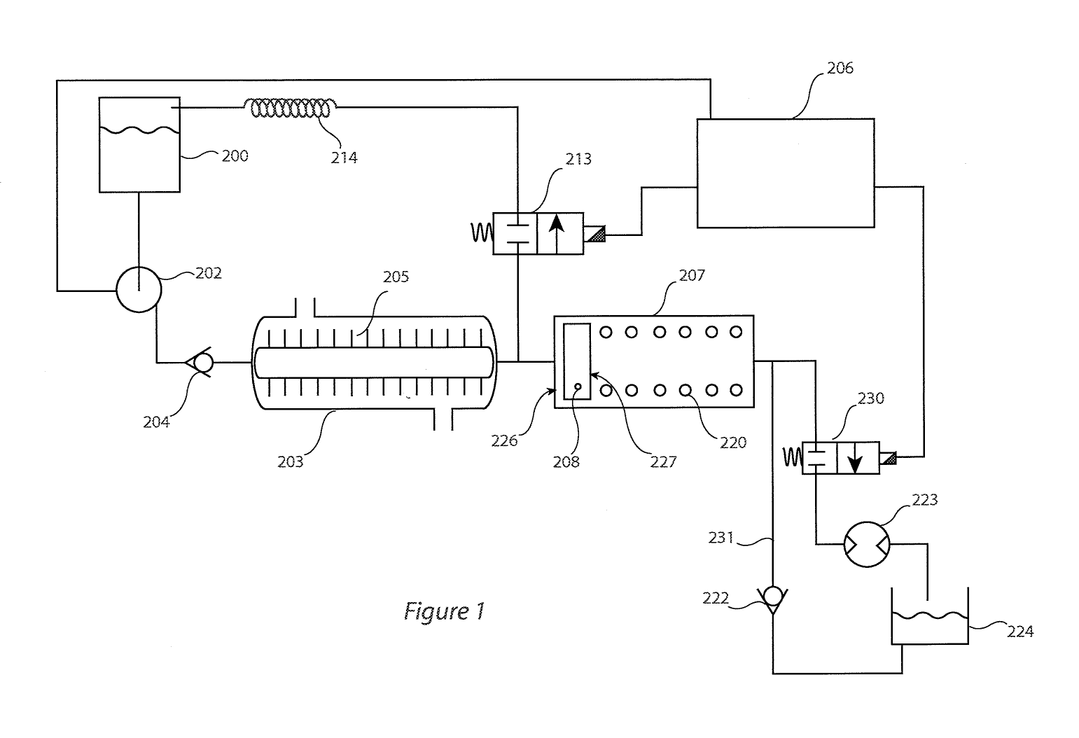

Referring to FIG. 1, the first embodiment of the heat engine of the present invention includes a working fluid reservoir 200 from which working fluid in liquid form is periodically injected by the pump 202 of a working fluid injecting means into a boiler 203. Reverse flow, such as may occur when pressure in the boiler 203 rises, is prevented by a check valve 204 which thus also forms part of the working fluid injecting means.

Heat is applied to the external heat transfer surface 205 on the boiler 203 from an external heat source (not shown) such as a hot liquid or gas which may be generated by combustion of a fuel, from solar energy, or may be waste heat from an industrial process. It will be appreciated that many other possibilities for an external heat source exist.

The boiler 203 communicates with an expander 207. A separator 208 in the expander 207 is shown at its start position, and has one surface 226 that communicates with the boiler 203. The other surface 227 of the separator 208 is in contact with a hydraulic fluid such as oil. The separator 208 is prevented from moving away from this start position by valve 230 preventing flow of the hydraulic fluid out of the expander 207. A check valve 222 ensures that no hydraulic fluid can escape from the expander 207 along path 231.

When the pressure in the boiler 203 increases to a predetermined threshold level, this is sensed or otherwise determined by the controller 206 which then operates valve 230 to allow hydraulic fluid to exit the expander 207 and move into a hydraulic motor 223 (following which the hydraulic fluid will flow into a reservoir 224). A rotary shaft output (not shown) from the hydraulic motor 223 can then be used for useful purposes such as propelling a vehicle, driving an alternator or generator to produce electricity, or to power a pump in order to pump water.

When the separator 208 reaches bottom dead centre (BDC), this is sensed or otherwise determined by the controller 206 which then acts to open the exhaust valve 213 and close valve 230, allowing working fluid to exit the expander 207 and enter a condenser 214. Working fluid is then returned to the reservoir 200 in liquid form. The separator 208 then moves to TDC under the influence of the spring 220.

As the separator 208 reaches TDC, the controller 206 causes the exhaust valve 213 and the valve 230 to be closed. As the valve 230 is closed, hydraulic fluid is drawn into the expander 207 from the reservoir 224 via the check valve 222. The valve 213 is closed and the pump 202 is again operated to inject liquid working fluid into the boiler 203 such that the cycle repeats.

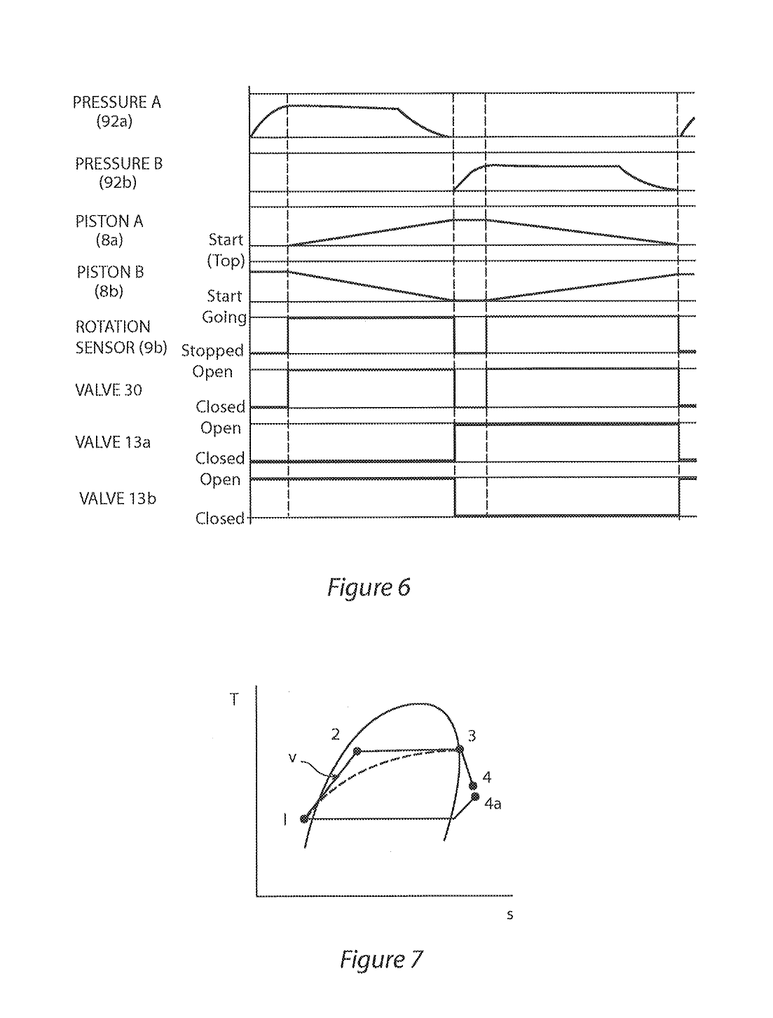

The cycle for the operation of the first embodiment shown in FIG. 1 will now be explained with reference to the thermodynamic cycle diagram shown in FIG. 7. This figure shows the thermodynamic cycle on a temperature—entropy (Ts) diagram.

When the separator 208 is at TDC and exhaust gases have been expelled via the valve 213, the valve 213 is closed. As soon as the valve 213 is closed, liquid working fluid is injected into the boiler 203 via the pump 202. At this point, the working fluid is a saturated or sub-cooled liquid. In FIG. 7, this state is shown at point 1, where the working fluid is shown slightly sub cooled.

As heat is added to the working fluid in the boiler 203, its temperature and pressure rise, whilst the volume it is held in stays constant due to the check valve 204, the closed exhaust valve 213 and the restrained separator 208 all preventing flow of working fluid out of the boiler 203. This rise is indicated by the constant volume line from state 1 to state 2 on FIG. 7. At state 2 the working fluid is typically still mostly saturated liquid. This line from state 1 to state 2 in FIG. 7 reflects the ideal case where the liquid is injected very quickly relative to the time required for the constant volume heating. A skilled addressee will appreciate that the actual path from state 1 to state 2 will deviate from that shown if the injection of liquid occurs more slowly.

When the pressure rises to the threshold level, the separator 208 is released allowing the working fluid to expand and do work against the first surface 226 of the separator 208. The liquid component of the working fluid will boil off during this stage of the cycle, and this is represented by the line from state 2 to state 3 on FIG. 7. However, it will be appreciated that, in practice, significant heat input would be required to maintain the horizontal line horizontal (and thus maintain the constant pressure and the constant temperature). While this is desirable in order to maximise efficiencies, it may not always be achieved and thus there may be some slight drop off in temperature or pressure from state 2 to state 3. At state 3 all of the liquid has boiled off.

The gas will continue to expand along the line from state 3 to state 4 in FIG. 7. In the ideal expansion process this will occur at constant entropy, which would appear as a vertical line on FIG. 7. In practice there will be an entropy increase, as actually shown in FIG. 7.

The exhaust valve 213 will be opened when dictated by the controller 206. In one form of the invention, this occurs when the pressure has dropped to the pressure in the condenser 214 or when the piston has reached BDC, whichever occurs first. With reference to FIG. 7, in the event that when the valve 213 opens the pressure in the expander 207 exceeds the condenser 214 pressure, the working fluid will move from state 4 as the valve opens to state 4a.

The working fluid is then expelled via the valve 213 into the condenser 214 as the piston moves back up to TDC. In the condenser 214, heat is removed from the working fluid and the working fluid is returned to state 1 and accumulates in the reservoir 200 as it exits the condenser 214.

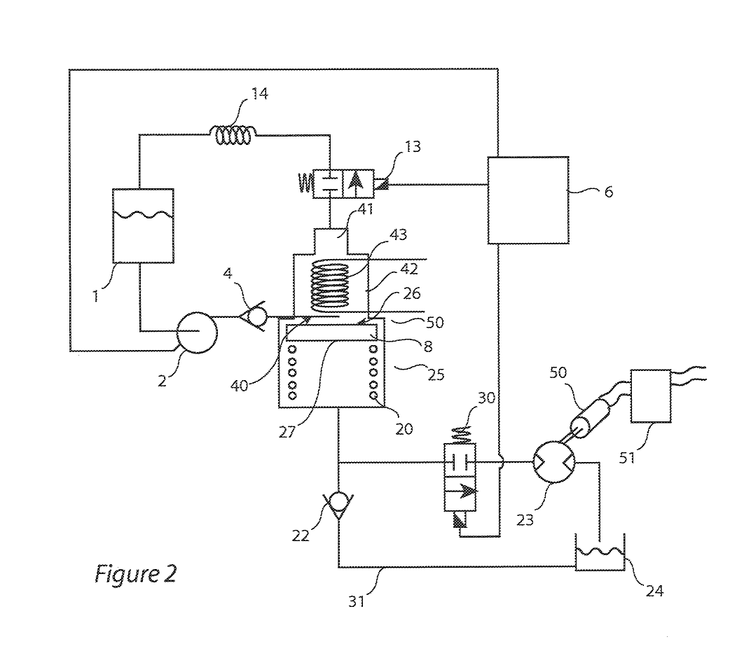

Referring to FIG. 2, the second embodiment of the heat engine of the present invention is somewhat similar to the first embodiment, and is an embodiment that includes a separator in the form of a disc 8, and that utilises a working fluid injecting means having an injector in the form of a nozzle 40, the liquid working fluid being injected via the nozzle 40 directly into heated hydraulic fluid in a boiler 42 having a different configuration to that described above in relation to FIG. 1, as will now be described in more detail.

The heat engine of the embodiment shown in FIG. 2 has a reservoir 1 from which liquid working fluid can be pumped by a pump 2 via a check valve 4. The working fluid is injected via the nozzle 40 (the nozzle 40, the pump 2 and the check valve 4 thus forming the abovementioned working fluid injecting means) into the hydraulic fluid in the boiler 42 above the separator disc 8 in a unit 25 that would be recognised by a skilled addressee as having the reasonably traditional appearance of a combined boiler/expander arrangement. The heating coil 43 in the boiler 42 is used to introduce heat from an external heating source (such as a solar heating source) into the hydraulic fluid in the boiler 42. In a different form of the invention, the hydraulic fluid could be transported using a suitable pump out of the boiler 42 to an external heater and then returned at a higher temperature.

When the liquid working fluid is introduced into the heated hydraulic fluid in the boiler 42, the liquid working fluid will be heated as a result of direct heat transfer between the hydraulic fluid and the working fluid. This will result in an increase in pressure of the working fluid (at constant volume) and a tendency for at least a portion of the working fluid to change to the gas phase. The gas will be buoyant and will tend to rise and collect in the top of the boiler 42, which is shown with a recess 41, to better collect this working fluid vapour.

A notional start position for the separator disc 8 is defined by limit stops in the form of shoulders 50 which prevent further motion of the separator disc 8 under the influence of a spring 20. This notional start position for the separator disc 8, as is shown in FIG. 2, would often be referred to as TDC. The increasing pressure of the working fluid vapour will act on the hydraulic fluid in the boiler 42, which in turn acts on the upper face 26 of the separator disc 8. The expansion stroke of the separator disc 8 commences when a control means in the form of a controller 6 operates a separator retaining means in the form of a separator retaining valve 30, allowing the hydraulic fluid below the separator disc 8 (the so-called “separator hydraulic fluid”) in communication with the lower face 27 of the separator disc 8, to enter a hydraulic motor 23.

In this embodiment, a load comprising an alternator 50 supplying electricity to a combined rectifier and inverter 51, which in turn supplies an AC electrical load (not shown), is shown. However, in another form, the valve 30 would not be included and the load characteristic of the inverter 51 would be such that the alternator 50, and hence also the motor 23, would rotate only at a low speed until the gas pressure in the boiler 42 rises sufficiently to cause the motor 23 to generate sufficient torque to rotate the alternator at a greater speed, at which stage the force required at the separator is reduced.

When the separator disc 8 reaches the end of its travel (again often referred to as BDC), an exhaust valve 13 is opened and the valve 30 is closed. The opening of the exhaust valve 13 allows the gaseous working fluid in the recess 41, and in the remainder of the boiler 42, to exit. The quantity of hydraulic fluid in the boiler 42 is then ideally such that, as the disc 8 returns to the notional start position under the influence of a spring 20, no boiler hydraulic fluid is expelled through the exhaust valve 13. In fact, it is desirable to ensure that a quantity of gas remains in the boiler volume which allows some compression space for liquid working fluid to be injected by the working fluid pump 2 without generating very high pressure.

As can thus be seen, although this embodiment includes a separator disc 8, and although that separator disc 8 itself reciprocates away from and towards its notional start position, there is nonetheless also still identifiable reciprocating motion of at least the separator hydraulic fluid, and it is this hydraulic fluid motion that is ultimately converted into useful work as per the above general statements of the invention.

The operating cycle of the heat engine of this second embodiment will now be explained, again with reference to the thermodynamic cycle diagram shown in FIG. 7.

When the separator disc 8 is at TDC and is retained in that position as mentioned above, and the exhaust gases from the previous cycle have been expelled via the exhaust valve 13, the exhaust valve 13 is closed. At about the same time, liquid working fluid is injected directly into the hydraulic fluid in the boiler 42 via the working fluid pump 2. At this point, the working fluid is a saturated or sub-cooled liquid. In FIG. 7 this state is shown at point 1, where the working fluid is shown slightly sub cooled.

As heat is added to the liquid working fluid in the boiler 42, its temperature and pressure rise, whilst the volume it is held in stays constant due to the check valve 4, the closed exhaust valve 13 and the restrained separator disc 8 all preventing flow of working fluid out of the boiler 42. This rise is indicated by the constant volume line from state 1 to state 2 in FIG. 7. At state 2, the working fluid is typically still mostly saturated liquid.

When the pressure in the boiler 42 rises to the threshold level, the separator disc 8 is released by virtue of the opening of the valve 30, allowing the working fluid to expand and do work against the upper surface 26 of the separator disc 8. The liquid component of the working fluid will boil off during this stage of the cycle (at state 3, all of the liquid has boiled off) and this is represented by the horizontal line from state 2 to state 3 on FIG. 7. However, it will again be appreciated that, in practice, significant heat input would be required to maintain the horizontal line horizontal (and thus maintain the constant pressure and the constant temperature). While this is desirable in order to maximise efficiencies, it may not always be achieved and thus there may be some slight drop off in temperature or pressure from estate 2 to state 3.

The gas will continue to expand along the line from state 3 to state 4 in FIG. 7. As mentioned above, in the ideal expansion process this will occur at constant entropy, which would appear as a vertical line in FIG. 7. However, in practice there will be an entropy increase, as is actually shown in FIG. 7.

The exhaust valve 13 will be opened when dictated by the controller 6. In one form of the invention, this occurs when the pressure has dropped to the pressure in the condenser 14 or when the separator disc 8 has reached BDC, whichever occurs first.

With reference to FIG. 7, in the event that when the exhaust valve 13 opens the pressure in the boiler 42 exceeds the condenser pressure, the working fluid will move from state 4 as the exhaust valve opens to state 4a.

The gaseous working fluid is then expelled via the exhaust valve 13 into the condenser 14 as the separator disc moves back up to TDC. In the condenser 14, heat is removed from the gaseous working fluid and the working fluid is returned to its liquid state at state 1 and again accumulates in the reservoir 1 as it exits the condenser 14.

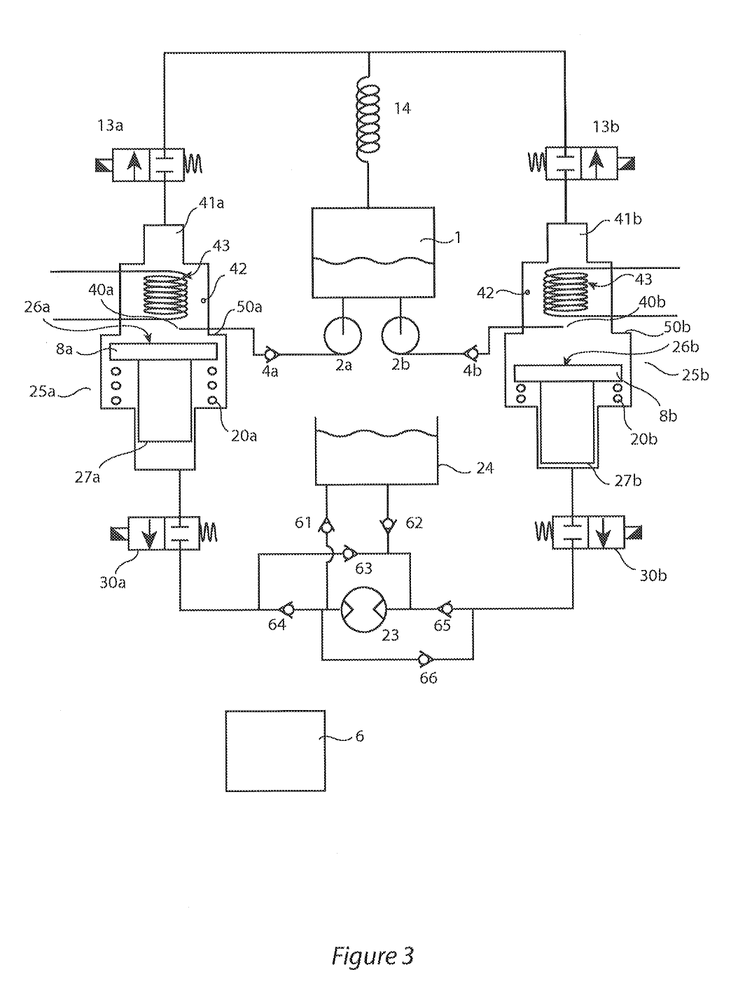

A disadvantage of the second embodiment for some applications is the intermittent nature of the power output. In this respect, it will be appreciated that during the return of the separator disc 8 to TDC (or the notional start position), and the delay in releasing the separator disc 8 from that notional start position whilst the boiler pressure increases, no power is being generated. Thus, a third embodiment shown in FIG. 3 uses two boilers 42, and two expanders 25a and 25b, operating alternately to reduce the period between power outputs. The “separators” in this embodiment are shown as “pistons” 8a,8b in the expander units 25a,25b, and both of these expander units 25a,25b thus generate a reciprocating flow of hydraulic fluid (again referred to as separator hydraulic fluid) which is fed into the single hydraulic motor 23 for conversion to useful work.

The check valves 63, 64, 65 and 66 ensure that the flow from each expander unit 25a,25b is fed through the hydraulic motor 23 in the same direction. The check valves 61 and 62 allow the hydraulic circuit to communicate with the hydraulic fluid tank 24 to enable hydraulic fluid to enter or exit the tank 24 in case the motions of the pistons 8a,8b, are not exactly equal and opposite. In this embodiment, the pistons 8a,8b have been configured to produce a pressure multiplication effect. This arises by the lower faces 27a,27b of the pistons 8a,8b being smaller than the opposing upper faces 26a,26b respectively of the pistons 8a,8b. This provides the advantage of lower flow rate and greater pressure of hydraulic fluid flowing through the motor 23, thus allowing a smaller motor to be used.

It will be apparent to those skilled in the art that any number of boilers and associated expanders can be used to power a single hydraulic motor.

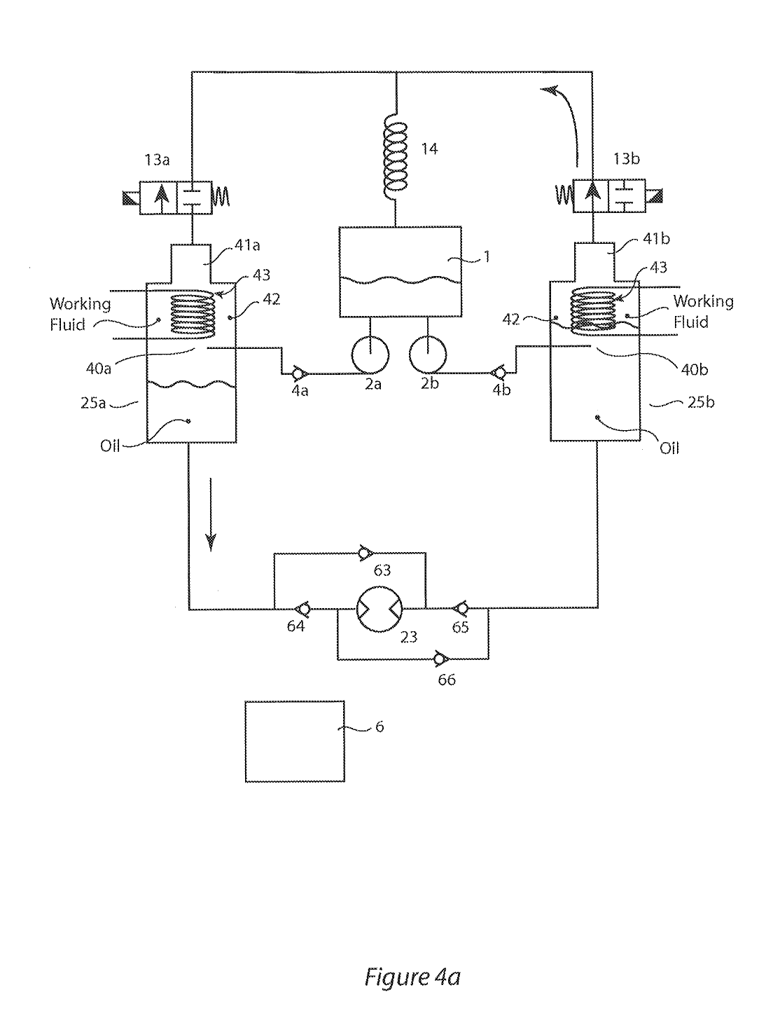

A fourth embodiment is shown in FIG. 4a, and a variation to this fourth embodiment is shown in FIG. 4b. The embodiment shown in FIG. 4a is similar to the third embodiment but differs in that the separator (namely, the solid pistons 8a,8b) has been omitted. This embodiment relies on the hydraulic fluid being that which experiences reciprocating motion of the type that is then converted to useful work, as will now be explained.

The valves 30a,30b of the third embodiment have also been omitted for this fourth embodiment, and the role of the hydraulic fluid retaining means (the separator retaining means in FIGS. 2 and 3) is instead played by the load resistance on the hydraulic motor 23 being used to restrict the rate of hydraulic fluid flow, ensuring that the pressure in the working fluid rises following injection through the nozzles 40a,40b. In this respect, FIG. 4a shows the boiler 25a part way through its power stroke with expanding working fluid pushing hydraulic fluid through the valve 64, the motor 23 and another valve 65 into the other boiler 25b which is in the process of expelling previously expanded working fluid through the exhaust valve 13b and into the condenser 14.

Further in relation to this fourth embodiment, the thermodynamic cycle described above will be changed slightly, in that instead of the substantially constant volume heating phase ending at state 2, there will be some increase in volume even at initial heat addition and the working fluid will follow the dotted line shown from state 1 to state 3 in FIG. 7.

Finally in relation to the fourth embodiment shown in FIG. 4a, to ensure that the working fluid volumes in the two boilers 25a,25b are always opposite, such that the cycle at each boiler 25a,25b is always 180 degrees out of phase, the tank 24 and the valves 61 and 62 have also been deleted from the third embodiment shown in FIG. 3.

A further alternative arrangement for a part of the fourth embodiment is shown in FIG. 4b, which illustrates an alternative form of boiler arrangement. The boiler 42c utilises a more traditional form of heat exchanger to transfer heat directly from a heating source 140 to the working fluid in line 141, and thus to change the state of the working fluid from liquid to gas, with the injection of the subsequent working fluid vapour via the nozzle 40. In this form, it is not a liquid working fluid that is injected, nor is there injection directly into the hydraulic fluid (namely, the oil). It will also be noted that, in this form, there is also no need to heat the hydraulic fluid. Indeed, in yet another form, the heating of the liquid working fluid, and its subsequent change of state, need not even occur within the arrangement shown in FIG. 4(a), but may occur away from that arrangement for subsequent transfer to that arrangement (which is similar in some respects to the general arrangement illustrated in the first embodiment shown in FIG. 1).

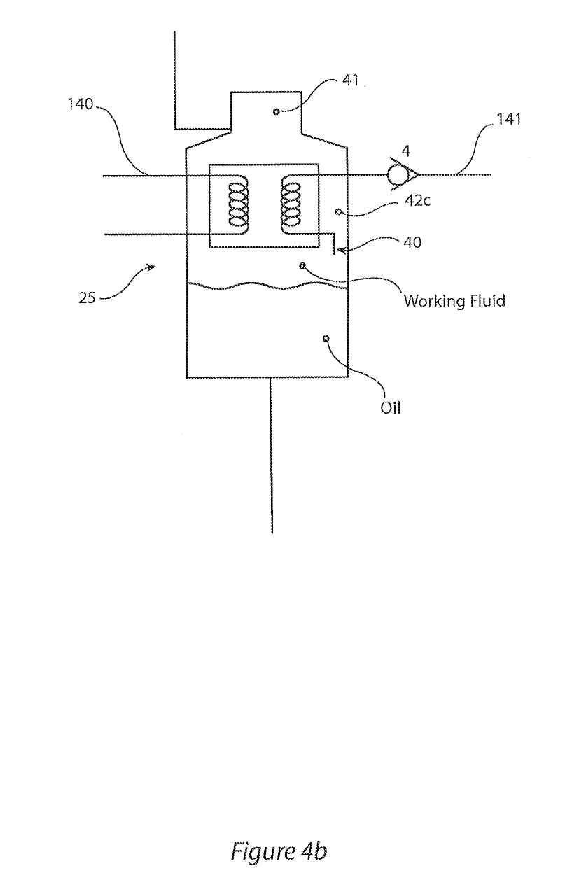

Turning now to a description of FIG. 5, FIG. 5 illustrates a fifth embodiment of the invention that is similar (in its cyclical and dual boiler reciprocating operation) to the fourth embodiment of FIG. 4a. FIG. 5 shows the cycle at a point where the power stroke of one of its pistons 8b is nearing completion. The other of its pistons 8a has already returned to the notional start position under the influence of the spring 20a, with hydraulic fluid being drawn up under the lower face 27a of the piston 8a from both the tank 24, via its check valves 61 and 63 and the motor 23, and from the hydraulic fluid volume below the lower face 27b of the piston 8b, via its check valves 66 and 63, the motor 23 and the valve 30. At this point, working fluid vapour has exited the boiler 42a via the valve 13a.

As the piston 8b comes to rest as a result of the working fluid in the boiler 42b above the piston face 26b being expanded to the extent that the force it provides against the piston 8b is no longer sufficient to move it further, the hydraulic fluid flow through the motor 23 will cease. This is sensed by a rotation sensor 91 and is communicated via a signal link (not shown) to the controller 6.

When the motor 23 stops rotating, a flywheel 80 and the alternator 50 are free to continue rotating due to the influence of an over-running clutch 81. This provides an uninterrupted power flow from the alternator 50 to the inverter 51 and thence to the electrical load connected to the inverter 51.

During each power stroke of either of the pistons 8a,8b, the pressure at the high pressure side of the motor 23 can be used to prime the pump 2. The high pressure hydraulic fluid communicates with the piston 120, forcing it up against the influence of the spring 121. The piston 120 then contacts the piston 122, pushing it up also, and causing it to draw in working fluid from the tank 1 via the check valve 132. Note that the vent line 111 allows pressure in void spaces in the pump 2 to remain relatively constant.

As soon as the cycle reaches the point where:
the piston 8a has returned to the notional start position against a shoulder 50a, and this has been sensed by the proximity sensor 90a and communicated to the controller 6 via a signal link (not shown); and
the piston 8b has stopped, causing the motor 23 to stop, and this is sensed by rotation sensor 91 and communicated to the controller 6 via a signal link (not shown); the controller 6 will:
cause the valve 13a to close, via an electrical connection (not shown);
cause the valve 13b to open, via an electrical connection (not shown);
cause the valve 30 to close, via an electrical connection (not shown); and
cause the valve 130 to open to the position where it allows liquid working fluid from the pump 2 to be injected under the influence of the spring 123 through the check valve 131 into the boiler 42a via the check valve 4a.

The injection of the working fluid is made possible by the pocket of working fluid vapour trapped in the recess 41a, which compresses as the working fluid is injected. As mentioned above in relation to other embodiments, the hydraulic fluid in the boiler 42a, heated by the heating coil 43a from an external heating source (not shown), transfers heat into the injected liquid working fluid, causing it to start to boil. The pressure in the boiler 42a increases as a result. This pressure is sensed by a pressure sensor 92a and communicated to the controller 6 via a signal link (not shown).

When the pressure in the boiler space 42a increases to the threshold level stored in, or calculated by, the controller 6, the controller 6 opens the valve 30, allowing the power stroke of the piston 8a to commence.

During this power stroke, the piston hydraulic fluid flows through the check valve 64, the valve 30 into the motor 23 and then through the check valve 62 to the tank 24, or via the check valve 65 to the hydraulic fluid volume below the lower face 27b of the piston 8b. The proportions of hydraulic fluid flowing each way at any point in time will be dictated by the speed with which the piston 8b rises under the influence of the spring 20b. Working fluid vapour exits from boiler 42b via the open valve 13b.

The motor 23 will rotate, and when its speed exceeds that of the flywheel 80, the over-run clutch 81 will engage the motor 23 to transmit power to the flywheel 80 and an alternator 50. This power is converted to electricity by the alternator 50 and this is converted to the desired voltage and frequency AC electricity by an inverter 51 to supply an external load (not shown).

As the piston 8a travels downwards, vapour in the space occupied by the spring 20a can then exit to the tank 24 via the passage 110a to prevent it being compressed. It can also travel onwards to the space occupied by the spring 20b via the passage 110b, allowing gas pressures in these spaces to remain balanced.

In this fifth embodiment, the working fluid exiting the boiler 42b via the valve 13b enters a hydraulic fluid separator 100 where any hydraulic fluid entrained with the working fluid is deposited. The working fluid then continues on to the condenser 14 where it is cooled and condensed back to a liquid. A float 101 allows any hydraulic fluid in the separator 100 to drain to tank 24. When all the hydraulic fluid has drained back, the float 101 acts as a plug preventing working fluid vapour being transported from the separator 100 to the tank 24. Any hydraulic fluid that does travel to the working fluid reservoir 1 is returned to the tank 24 via a flexible tube 141 which is connected to a float 140. The float 140 floats on the working fluid but sinks in the less dense hydraulic fluid, thus allowing the hydraulic fluid to enter the tube 141 intake.

The downwards power stroke of piston 8a will continue until the working fluid vapour in the boiler 42a has expanded to the extent that the force it applies to the piston 8a is no longer sufficient to push it further. At this point, the motor 23 will stop which will be sensed by the sensor 91. At this point also, the piston 120 will have moved downwards under the influence of the spring 121, as the pressure at the motor 23 is no longer great enough to hold it up. As it does so, hydraulic fluid is drawn into the cavity occupied by the spring 121 from the tank 24 via the check valve 140.

As an alternative to the use of a rotation sensor 91 in order to control the action of the exhaust valves 13a,13b, means could be provided that senses that the pressure in the boiler has not varied for some time, and thus the motor is not moving, and use that information to open the exhaust valves 13a,13b as appropriate. In this form, it would not be necessary to include a sensor on the motor 23, which may be attractive in some forms.

At the next power stroke of either of the pistons 8a,8b, when the piston 120 is forced upwards, this hydraulic fluid will be expelled either via a respective one of the valves 141a,141b to a respective one of the boilers 42a,42b. This ensures that any hydraulic fluid that is expelled from the boilers 42a,42b during the working fluid exhaust stage is replaced. The hydraulic fluid will tend to travel through the valve 141a when the piston 8b is on its power stroke, and through the valve 141b when the piston 8a is on its power stroke, as the hydraulic fluid will tend to flow to the lowest pressure space.

When the piston 8b is at its notional start position, as sensed by proximity sensor 50b, the controller 6 will open the valve 13a, allowing working fluid to exit the boiler 42a. It will also close the valve 30 and inject liquid working fluid into the boiler 42b by opening the valve 130 to the required position. At this point, the pressure in the boiler 42b will start to increase in the manner previously described for the boiler 42a. When the threshold pressure is reached, the power stroke for the piston 8b will commence in the same manner as that described for the piston 8a previously. This brings the cycle back to the point where the description of it commenced.

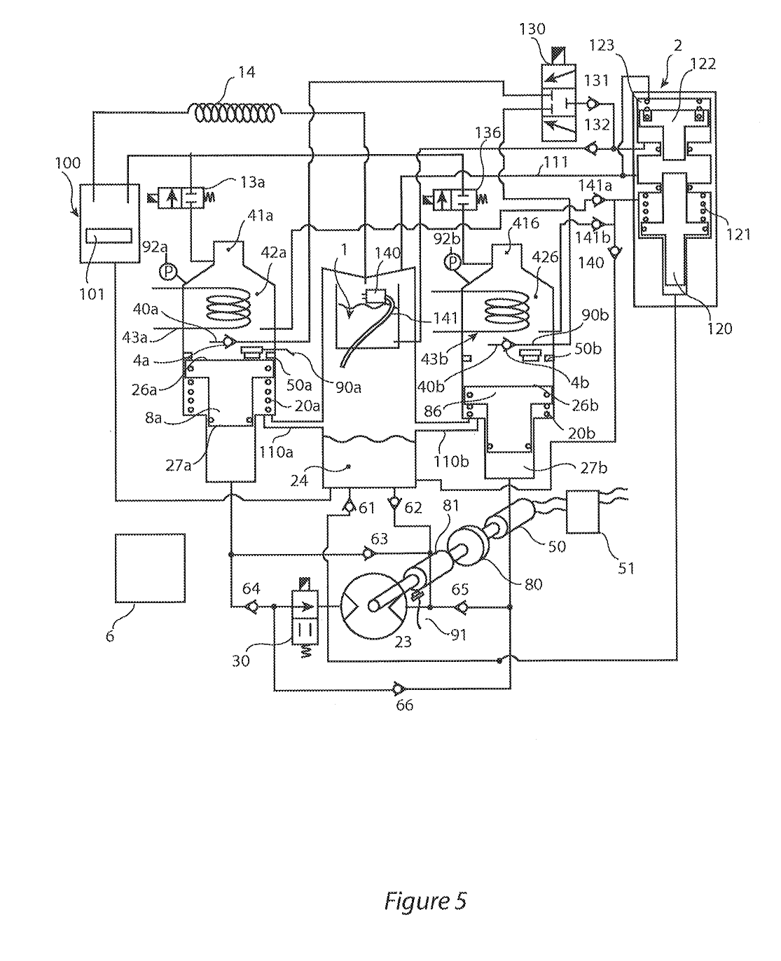

The timing of key elements of the cycle is shown on the timing diagram in FIG. 6.

Finally, there may be other variations and modifications made to the configurations described herein that are also within the scope of the present invention.

1. A heat engine that that is capable of converting reciprocating motion of hydraulic fluid exiting a boiler, under the influence of working fluid vapour pressure, to useful work, the heat engine including:
the boiler;
a working fluid injecting means for injecting working fluid into the boiler;
a hydraulic fluid retaining means capable of releasing the hydraulic fluid for movement away from a start position once working fluid vapour pressure in the boiler reaches a predetermined level;
a hydraulic fluid return means to return the hydraulic fluid to its start position following expansion of working fluid vapour in the boiler, resulting in reciprocating hydraulic fluid motion;
an exhaust valve to release expanded working fluid vapour from the boiler;
wherein the vapour pressure increase in the boiler prior to the hydraulic fluid moving away from the start position is caused by a substantially constant volume heating of working fluid causing a change of state from liquid to gas of a least a portion of the injected working fluid, followed by a substantially constant pressure heating of the working fluid giving rise to a change of state from liquid to gas of substantially all of the remaining injected working fluid.

2. A heat engine according to claim 1, wherein the heating of working fluid results from heat transfer from an external heat source to the hydraulic fluid and then from heated hydraulic fluid to the working fluid.

3. A heat engine according to claim 1, wherein the heating of working fluid results from heat transfer from an external heat source to the working fluid.

4. A heat engine according to claim 1, wherein the heat engine includes hydraulic fluid above and below a separator, the hydraulic fluid above the separator being within the boiler (the boiler hydraulic fluid) and the hydraulic fluid below the separator (the separator hydraulic fluid) being in fluid communication with a power conversion means to convert reciprocating separator motion to useful work.

5. A heat engine according to claim 4, wherein the vapour pressure increase in the boiler prior to the separator moving away from a start position is caused by a substantially constant volume heating of working fluid, injected as a liquid directly into the boiler hydraulic fluid, and the subsequent change of state from liquid to gas of a least a portion of the injected working fluid.

6. A heat engine according to claim 1, wherein the working fluid injecting means includes a pump for the controlled injection of the working fluid into the boiler.

7. A heat engine according to claim 6, wherein the pump is operable via a control means.

8. A heat engine according to claim 1, wherein the hydraulic fluid retaining means is a retaining valve incorporated within the line of the hydraulic fluid.

9. A heat engine according to claim 8, wherein the retaining valve is operable via a control means, in response to the vapour pressure in the boiler.

10. A heat engine according to claim 1, wherein the working fluid circulates through the heat engine in a closed loop with the expanded working fluid vapour from the boiler being returned to a liquid state in a condenser after exiting the exhaust valve.

11. A heat engine according to claim 1, wherein the hydraulic fluid is heated by an external heat source in the form of a solar heat collector.

12. A heat engine according to claim 1, wherein, in use, when the pressure in the boiler has increased to a predetermined threshold level, a control means causes the hydraulic fluid retaining means to allow the hydraulic fluid to move away from the start position under the influence of the pressure of the working fluid.

13. A heat engine according to claim 1, wherein, in use, a control means senses force applied to the hydraulic fluid and causes the hydraulic fluid retaining means to allow the hydraulic fluid to move away from the start position when a threshold force is reached.

14. A heat engine according to claim 1, wherein the heat engine includes a separator and wherein, in use, the hydraulic fluid retaining means is a separator retaining means that includes mechanical stops that provide a physical retention of the separator, the stops being withdrawn in response to a signal from a control means, the signal either being boiler pressure responsive or separator force responsive.

15. A heat engine according to claim 1, wherein the hydraulic fluid retaining means is provided by load characteristics of the power conversion means.

16. A heat engine according to claim 1, wherein the heat engine includes a separator and there is no hydraulic fluid below the separator, and wherein the motion of the separator under the influence of the expanding working fluid vapour is used to do useful work by the conversion of the reciprocating motion of the separator into rotary motion of a crankshaft via a connecting rod.

17. A heat engine according to claim 1, substantially as herein described in accordance with the accompanying drawings.

18. A method of operating a heat engine, the heat engine including:
a boiler;
a working fluid injecting means for injecting working fluid into the boiler;
a hydraulic fluid retaining means capable of releasing the hydraulic fluid for movement away from a start position once working fluid vapour pressure in the boiler reaches a predetermined level;
a hydraulic fluid return means to return the hydraulic fluid to its start position following expansion of working fluid vapour in the boiler;
an exhaust valve to release expanded working fluid vapour from the boiler;
the method including the substantially constant volume heating of working fluid injected into the boiler, causing a change of state from liquid to gas of a least a portion of the injected working fluid, the resultant vapour pressure increase in the boiler causing the hydraulic fluid to move away from the start position resulting in reciprocating hydraulic fluid motion, followed by a substantially constant pressure heating of the working fluid, giving rise to a change of state from liquid to gas of substantially all of the remaining injected working fluid.

19. A method according to claim 18, wherein the heating of working fluid results from heat transfer from an external heat source to the hydraulic fluid and then from heated hydraulic fluid to the working fluid.

20. A method according to claim 18, wherein the heating of working fluid results from heat transfer from an external heat source to the working fluid.

21. A method according to claim 18, wherein the heat engine includes hydraulic fluid above and below a separator, the hydraulic fluid above the separator being within the boiler (the boiler hydraulic fluid) and the hydraulic fluid below the separator (the separator hydraulic fluid) being in fluid communication with a power conversion means to convert reciprocating separator motion to useful work.

22. A method according to claim 21, wherein the vapour pressure increase in the boiler prior to the separator moving away from a start position is caused by a substantially constant volume heating of working fluid, injected as a liquid directly into the boiler hydraulic fluid, and the subsequent change of state from liquid to gas of a least a portion of the injected working fluid.

23. A method according to claim 18, wherein the working fluid which changes state from liquid to gas on heating circulates through the heat engine in a closed loop.

24. A method according to claim 23, wherein expanded working fluid vapour is returned to its liquid state in a condenser after exiting the exhaust valve.

25. A method according to claim 18, including heating the hydraulic fluid using an external heat source in the form of a solar heat collector.

26. A method according to claim 18, including using a control means to cause the hydraulic fluid retaining means to allow the hydraulic fluid to move away from the notional start position under the influence of the pressure of the working fluid, when the pressure in the boiler has increased to a predetermined threshold level.

27. A method according to claim 18, including sensing the force applied to the hydraulic fluid by the expanding gases, and using a control means to cause the hydraulic fluid retaining means to allow the hydraulic fluid to move away from the notional start position under the influence of the pressure of the working fluid, when the threshold force is reached.

28. A method according to claim 18, the heat engine including a separator, and the method including using mechanical stops to provide a physical retention of the separator, the stops being withdrawn in response to a signal from a control means, the signal either being boiler pressure responsive or separator force responsive.

29. A method according to claim 18, the heat engine including a separator, and the method including sensing the halting of hydraulic fluid motion, either due to the hydraulic fluid reaching a physical stop or due to remaining pressure in the boiler no longer being sufficient to move the hydraulic fluid against a load, and then opening the exhaust valve to allow the expanded gases of the working fluid to communicate with a working fluid condenser.

30. A method according to claim 18, substantially as herein described in relation to the accompanying drawings.
